(19) United States
(12) Patent Application Publication
(10) Pub. No.: US 2020/0284186 A1
(43) Pub. Date: Sep. 10, 2020

(54) Engine Valvetrain Controls as Connecting Valves for Dual-Volute Turbochargers

(71) Applicant: BorgWarner Inc., Auburn Hills, MI (US)

(72) Inventor: John Joseph Palko, Arden, NC (US)

(73) Assignee: BorgWarner Inc., Auburn Hills, MI (US)

(21) Appl. No.: 16/292,633

(22) Filed: Mar. 5, 2019

(51) Int. Cl. F02B 37/02; F02B 37/18; F02B 33/40; F02C 6/12

(52) U.S. Cl. CPC F02B 37/025; F02C 6/12; F02B 33/40; F02B 37/183

(57) ABSTRACT

A method is disclosed for controlling exhaust gas flow from a combustion engine to a turbocharger. The combustion engine includes a plurality of cylinders each with first and second exhaust valves, and the turbocharger includes first and second volutes with outlets that are separated by approximately 180°. The method includes: (i) directing exhaust flow from first and second cylinders into the first volute via a first exhaust channel by opening the first exhaust valve in the first and second cylinders; (ii) directing exhaust flow from third and fourth cylinders into the second volute via a second exhaust channel by opening the first exhaust valve in the third and fourth cylinders; and (iii) apportioning exhaust flow from each cylinder into the first and second volutes via the first and second exhaust channels by moving the second exhaust valve in each cylinder between a variety of positions.

### TECHNICAL FIELD

The present disclosure relates generally to systems and methods for varying the flow of engine exhaust gas into a dual-volute turbocharger.

### BACKGROUND

Combustion engine systems combine and combust air and fuel to generate mechanical power. Typically, air is directed into a combustion engine by an (upstream) induction system, and the exhaust gas created as a result of the combustion is generally carried away by a (downstream) exhaust system. The performance of combustion engine systems, and the power generated, is thus directly influenced by the amount of air that is fed into the system for combustion.

A turbocharger is an auxiliary system that is used to increase the amount of air being fed into the system to increase overall performance and the amount of power that is generated. In general, turbochargers include a turbine that is rotatably driven by the exhaust gas from the engine and a compressor that is connected to the turbine such that rotation of the turbine causes corresponding rotation of the compressor. As the compressor rotates, air is drawn into the turbocharger for compression, and the compressed air is fed into the engine. In a dual-volute design, the turbine housing of the turbocharger includes a pair of curved ducts, commonly known as volutes, that guide and redirect the exhaust gas to cause rotation of the turbine.

The present disclosure provides for improvements in dual-volute turbocharger performance by varying operation of an engine's exhaust valves to increase control over the amount of exhaust gas entering each volute of the turbocharger.

### SUMMARY

In one aspect of the present disclosure, a method is disclosed for controlling the flow of exhaust gas from a combustion engine to a turbocharger having first and second volutes (e.g., outlets that are separated by approximately 180°, as in a dual-volute turbocharger, or outlets that are generally adjacent, as in a twin-scroll turbocharger). The combustion engine includes a plurality of cylinders each with first and second exhaust valves, and the method includes: (i) directing exhaust flow from first and second cylinders into the first volute via a first exhaust channel by opening the first exhaust valve in each of the first and second cylinders; (ii) directing exhaust flow from third and fourth cylinders into the second volute via a second exhaust channel by opening the first exhaust valve in each of the third and fourth cylinders; and (iii) apportioning exhaust flow from each cylinder into the first and second volutes via the first and second exhaust channels by moving the second exhaust valve in each cylinder between a variety of positions.

In certain embodiments, apportioning the exhaust flow may include closing the second exhaust valve in each cylinder such that the first volute is fed exclusively by exhaust gas from the first and second cylinders, and the second volute is fed exclusively by exhaust gas from the third and fourth cylinders.

In certain embodiments, apportioning the exhaust flow may include partially opening the second exhaust valve in each cylinder such that the exhaust gas from each cylinder is at least partially directed into each of the first and second volutes.

In certain embodiments, apportioning the exhaust flow may include fully opening the second exhaust valve in each cylinder.

In certain embodiments, the method may further include repositioning a single wastegate valve that is positioned downstream of the combustion engine to simultaneously vary the exhaust flow into the first and second volutes.

In certain embodiments, repositioning the wastegate valve may include opening the wastegate valve to simultaneously reduce the exhaust flow into the first and second exhaust channels and the first and second volutes.

In certain embodiments, the method may further include positioning the first and second exhaust valves in each cylinder such that the exhaust flow is prohibited from entering the first exhaust channel, whereby the exhaust flow is directed exclusively into the second exhaust channel.

In certain embodiments, positioning the first and second exhaust valves to prohibit exhaust flow into the first exhaust channel may occur prior to, or during, an initial startup phase.

In certain embodiments, opening the wastegate valve may cause a portion of exhaust gas from the combustion engine to bypass the turbocharger and flow directly from the combustion engine into an exhaust aftertreatment (e.g., a catalytic converter) positioned downstream of the turbocharger through the wastegate valve to thereby increase a rate at which the exhaust aftertreatment is heated.

In another aspect of the present disclosure, an engine system is disclosed that includes: (i) a combustion engine; (ii) a turbocharger; and (iii) a valve positioning system. The combustion engine includes a plurality of cylinders each with a first exhaust valve and a second exhaust valve. The turbocharger is in communication with the combustion engine and includes a first volute having an inlet and an outlet, and a second volute having an inlet and an outlet. For example, in a dual-volute turbocharger, the outlets of the first and second volutes would be offset by approximately 180°, whereas in a twin-scroll turbocharger, the outlets of the first and second volutes would be generally adjacent to each other. The valve positioning system is configured to reposition the first and second exhaust valves in each cylinder such that the combustion engine is operable in a plurality of modes including: (i) a first mode, in which the first exhaust valve of each cylinder is fully open and the second exhaust valve of each cylinder is closed such that the first volute is fed exclusively by exhaust gas from a first plurality of cylinders through a first exhaust channel, and the second volute is fed exclusively by exhaust gas from a second, different plurality of cylinders through a second exhaust channel; (ii) a second mode, in which the first and second exhaust valves of each cylinder are fully open such that exhaust gas from each cylinder flows into each of the first and second volutes; and (iii) a third mode, in which the first exhaust valve of each cylinder is fully open and the second exhaust valve of each cylinder is partially open to vary exhaust flow from each cylinder into each of the first and second volutes.

In certain embodiments, the plurality of cylinders may include a first cylinder, a second cylinder, a third cylinder, and a fourth cylinder.

In certain embodiments, the valve positioning system may be configured such that, in the first mode, the first volute is fed exclusively by exhaust gas from the first and fourth cylinders, and the second volute is fed exclusively by exhaust gas from the second and third cylinders.

In certain embodiments, the engine system may further include a single wastegate valve that is positioned downstream of the combustion engine (i.e., in communication with the first exhaust channel, which may extend between the combustion engine and the first volute, or in the second exhaust channel, which may extend between the combustion engine and the second volute) to simultaneously vary the exhaust flow into the first and second volutes.

In certain embodiments, the engine system may further include an exhaust aftertreatment that is positioned downstream of the turbocharger. In such embodiments, the wastegate valve may be positioned upstream of the exhaust aftertreatment.

In certain embodiments, the wastegate valve may be movable between an open position, in which a portion of the exhaust gas from the combustion engine bypasses the turbocharger and flows directly into the exhaust aftertreatment, and a closed position, in which exhaust gas is prevented from bypassing the turbocharger and flowing directly from the combustion engine into the exhaust aftertreatment (i.e., such that the exhaust gas is directed through the turbocharger before reaching the exhaust aftertreatment).

In another aspect of the present disclosure, a method is disclosed for operating a vehicle that is powered by a turbocharger having first and second volutes, and a combustion engine having a plurality of cylinders each with first and second exhaust valves. The method includes: (i) positioning the first and second exhaust valves in each cylinder such that exhaust gas is prohibited from flowing into a first exhaust channel extending between the combustion engine and a first volute of the turbocharger, whereby the exhaust gas flows exclusively into a second exhaust channel extending between the combustion engine and a second volute of the turbocharger; and (ii) opening a wastegate valve that is positioned between the combustion engine and the turbocharger such that a portion of the exhaust gas bypasses the turbocharger and flows directly from the combustion engine into an exhaust aftertreatment that is positioned downstream of the turbocharger to thereby increase a rate at which the exhaust aftertreatment is heated, and increase performance of the exhaust aftertreatment during an initial startup phase of the vehicle (e.g., when the exhaust aftertreatment is cold).

In certain embodiments, the method may further include operating the vehicle in a first mode, after the initial startup phase is complete, in which the first exhaust valve of each cylinder is open, and the second exhaust valve of each cylinder is closed such that the first volute is fed exclusively by exhaust gas from a first plurality of cylinders, and the second volute is fed exclusively by exhaust gas from a second, different plurality of cylinders.

In certain embodiments, the method may further include operating the vehicle in a second mode in which the first and second exhaust valves of each cylinder are fully open such that exhaust gas from each cylinder flows into each of the first and second volutes.

In certain embodiments, the method may further include operating the vehicle in a third mode, occurring between the first mode and the second mode, in which the second exhaust valve of each cylinder is partially open to vary exhaust flow from each cylinder into each of the first and second volutes.

### BRIEF DESCRIPTION OF THE DRAWINGS

The disclosure is best understood from the following detailed description when read in conjunction with the accompanying drawings. It is emphasized that, according to common practice, the various features of the drawings may not be to scale, and that the dimensions of the various features may be arbitrarily expanded or reduced for clarity.

FIG. 1 illustrates an engine system including an engine and a dual-volute turbocharger.

FIG. 2 is a schematic representation of the engine system seen in FIG. 1 illustrating the flow of exhaust gas from the engine to the turbocharger.

FIG. 3A is a cross-sectional view of the turbocharger seen in FIG. 1.

FIG. 3B is a cross-sectional view of an alternate (twin-scroll) embodiment of the turbocharger seen in FIG. 1.

FIG. 4 is a schematic representation of an alternate embodiment of the engine system including a wastegate valve.

### DETAILED DESCRIPTION

The present disclosure describes systems and methods for controlling the flow of exhaust gas from a combustion engine into a turbocharger (e.g., a dual-volute turbocharger) by varying the positions of the exhaust valves in the engine. For example, when operating in a first mode (e.g., at lower engine speeds), certain exhaust valves may be closed such that exhaust gas from a plurality of first cylinders is directed into a first volute of the turbocharger (e.g., via a first exhaust channel), and exhaust gas from a plurality of second cylinders is directed into a second volute of the turbocharger (e.g., via a second exhaust channel). For example, in the context of a four-cylinder engine, exhaust gas from cylinders one and four may be directed into the first volute, and exhaust gas from cylinders two and three may be directed into the second volute. In a second mode of operation (e.g., at higher engine speeds), however, each of the exhaust valves may be (partially or fully) opened such that exhaust gas from each of the cylinders is directed into each of the volutes. By varying the extent to which the exhaust valves are opened, smoother transitions can be achieved as the speed of the engine fluctuates, and backpressure within the turbocharger can be modulated to increase overall performance and/or efficiency.

In various embodiments of the disclosure, a (single) wastegate valve may also be incorporated, which may be positioned in either the first exhaust channel or the second exhaust channel, to further increase control over the volume of exhaust gas entering the turbocharger. In such embodiments, the wastegate valve may be opened or closed to vary the flow of exhaust gas into either, or both, of the exhaust channels. In certain implementations, by varying the positions of the exhaust valves and the wastegate valve, exhaust gas may be routed directly from the engine into an exhaust aftertreatment to increase the rate at which the exhaust aftertreatment is heated, and thereby reduce the amount of time required for sufficient heating to occur.

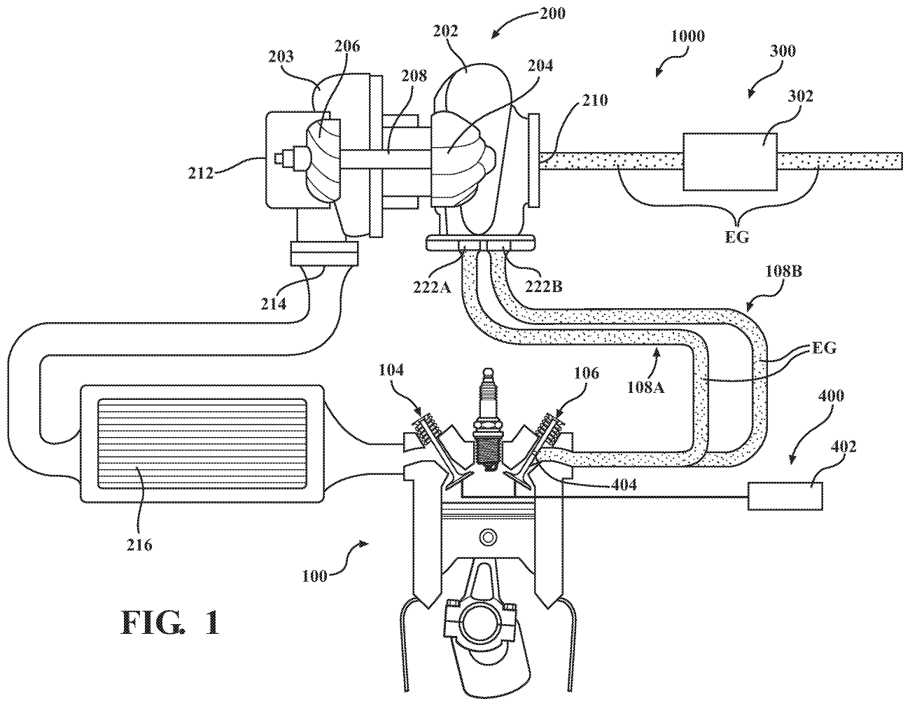

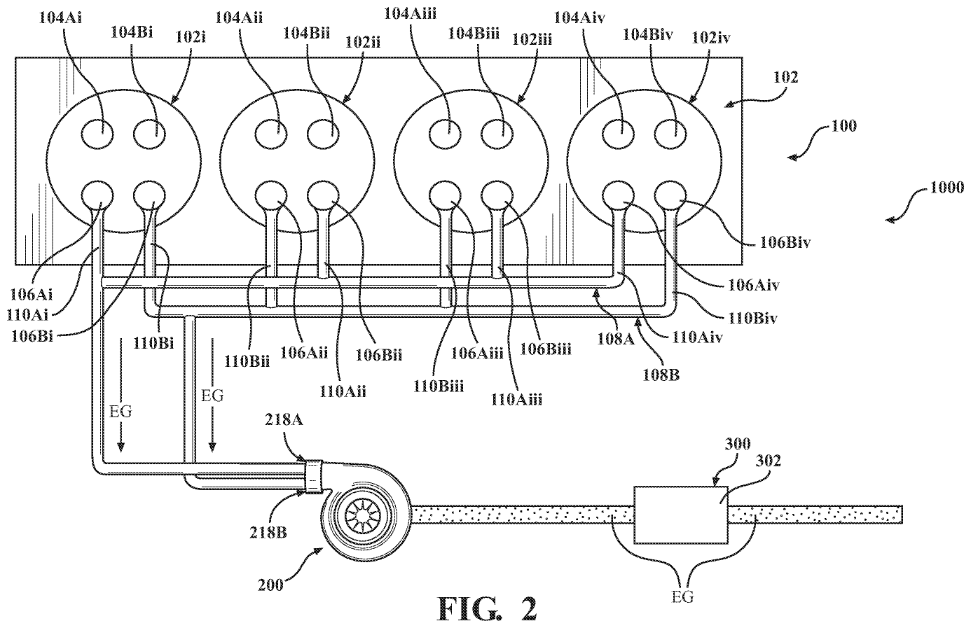

Referring now to the figures, FIGS. 1 and 2 illustrate an engine system 1000 that includes an internal combustion engine 100, a turbocharger 200, and an exhaust system 300 including an exhaust aftertreatment 302 (e.g., a catalytic converter) that is positioned downstream of the engine 100 and the turbocharger 200 to carry away exhaust gas EG created by the engine 100. The engine system 1000 is intended to be generally representative of components that may be used to implement the methods of controlling flow of the exhaust gas EG into the turbocharger 200 described herein, and it should be understood that the components of the engine system 1000 may be varied in alternate embodiments of the disclosure.

The engine 100 is configured to combust a mixture of fuel and air for conversion into mechanical energy and may assume a variety of configurations in various embodiments of the present disclosure. For example, the engine 100 may be configured as a spark-ignition engine (e.g., a gasoline engine), an autoignition or compression-ignition engine (e.g., a diesel engine), a rotary engine, etc.

In the particular embodiment shown throughout the figures, the engine 100 includes a plurality of cylinders 102i-102iv (FIG. 2) having associated intake valves 104 and exhaust valves 106. More specifically, in the illustrated embodiment, the (first) cylinder 102i includes (left and right) intake valves 104Ai, 104Bi and (left and right) exhaust valves 106Ai, 106Bi, the (second) cylinder 102ii includes (left and right) intake valves 104Aii, 104Bii and (left and right) exhaust valves 106Aii, 106Bii, the (third) cylinder 102iii includes (left and right) intake valves 104Aiii, 104Biii and (left and right) exhaust valves 106Aiii, 106Biii, and the (fourth) cylinder 102iv includes (left and right) intake valves 104Aiv, 104Biv and (left and right) exhaust valves 106Aiv, 106Biv. Operation and timing of the exhaust valves 106 is governed by a valve positioning system 400 (FIG. 1), which may include any components and/or mechanisms suitable for the intended purpose of independently controlling the positions of the exhaust valves 106, such as, for example, camshafts, solenoids, or the like, a controller 402, one or more sensors 404 (e.g., positioned on the exhaust valves 106), etc. In certain embodiments of the disclosure, it is envisioned that the valve positioning system 400 may be configured and connected to each of the exhaust valves 106Ai-106Aiv, 106Bi-106Biv, or alternatively, that the valve positioning system 400 may be configured and connected to a single set of the exhaust valves 106 only (e.g., to the exhaust valves 106Bi-106Biv).

Although the engine 100 is shown as including four cylinders 102 (i.e., cylinders 102i-102iv) in the illustrated embodiment, it should be appreciated that, in alternate embodiments of the disclosure, any suitable number of cylinders 102 may be included and arranged in any suitable configuration. It is also envisioned that the particular size (e.g., displacement) of the engine 100 may be varied and that the engine 100 may function across a wide range of parameters. For instance, it is envisioned that idle speeds for the engine 100 may fall substantially within the range of approximately 500 RPM to approximately 1000 RPM and that a maximum speed for the engine 100 may fall substantially within the range of approximately 5000 RPM to approximately 8000 RPM, although operating parameters outside of these ranges would not be beyond the scope of the present disclosure. Throughout the following discussion, the term “low speed” (and variations thereof) should be understood to include from approximately 0% to approximately 33% of the maximum speed of the engine 100, the term “intermediate speed” should be understood to include from approximately 25% to approximately 75% of the maximum speed of the engine 100, and the term “high speed” (and variations thereof) should be understood to include from approximately 66% to approximately 100% of the maximum speed of the engine 100.

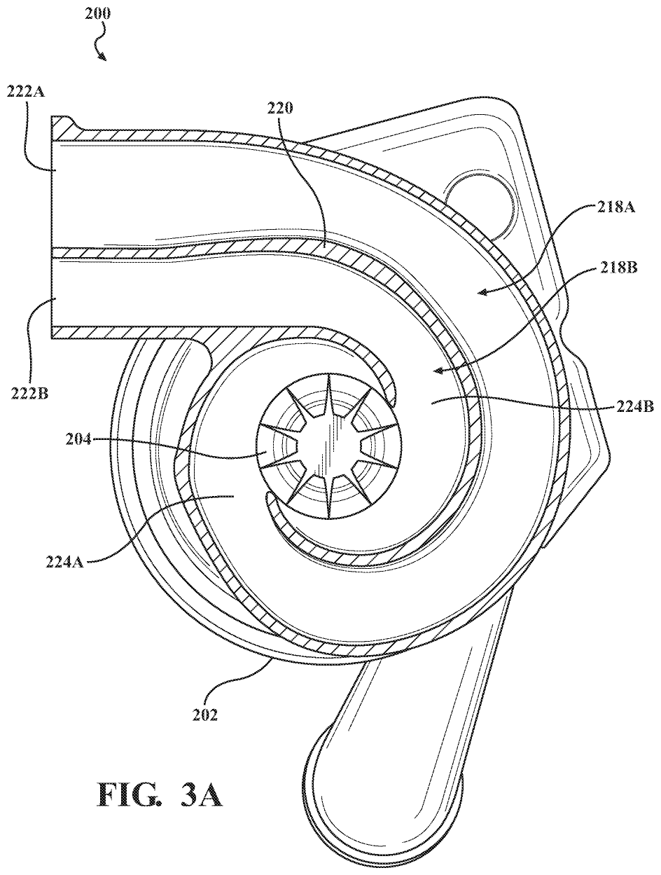

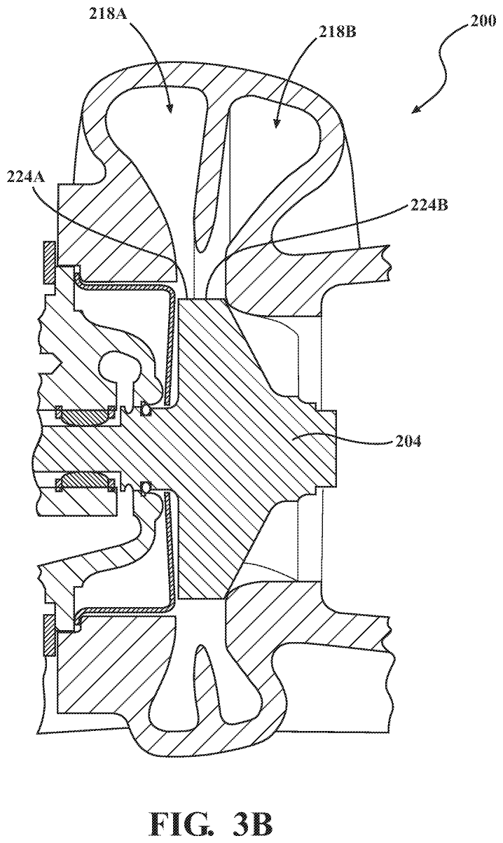

With reference now to FIG. 3A as well, the turbocharger 200 includes a turbine housing 202 that accommodates a turbine 204 and a compressor housing 203 that accommodates a compressor 206. The compressor 206 is mechanically connected to the turbine 204 via a shaft 208 such that rotation of the turbine 204 causes corresponding rotation of the compressor 206. During operation of the engine 100, the exhaust gas EG is fed into the turbocharger 200 so as to cause rotation of the turbine 204 and thus, the compressor 206, and the exhaust gas EG exits the turbocharger 200 through an exhaust outlet 210 (FIG. 1) for aftertreatment by the exhaust system 300 (e.g., by the exhaust aftertreatment 302), as described in further detail below. As the compressor 206 rotates, air is drawn into the turbocharger 200 via an air inlet 212 for compression. After compression, the compressed air exits the turbocharger 200 via an air outlet 214 and is fed into the engine 100 through the intake valves 104 for combustion. As seen in FIG. 1, in certain implementations, the compressed air may be fed into a cooler 216 prior to entering the engine 100.

Throughout the present disclosure, the turbine housing 202 of the turbocharger 200 is shown and described as having a dual-volute construction. More specifically, as shown in FIG. 3A, the turbine housing 202 includes respective first and second volutes 218A, 218B, each of which is curved (spiraled) in configuration so as to direct the exhaust gas EG into the turbine 204 to cause the turbine 204 to rotate. The volutes 218A, 218B are separated by a wall 220 and include respective inlets 222A, 222B, and outlets 224A, 224B that are positioned adjacent to turbine 204 and are offset by approximately 180°. It should be appreciated, however, that alternate configurations for the turbocharger 200 would not be beyond the scope of the present disclosure. For example, in various embodiments, it is envisioned that curvature, orientations, radii, volumes, etc., of the volutes 218A, 218B may be altered to achieve any desired result. Additionally, it is envisioned that the construction of the turbocharger 200 itself may be varied from the dual-volute design discussed herein. For example, as seen in FIG. 3B, the turbocharger 200 may include a twin-scroll construction in which the volutes 218A, 218B and, thus, the outlets 224A, 224B, are positioned in generally adjacent (side-by-side) relation such that each of the volutes 218A, 218B covers 360° of the turbine 204.

As seen in FIG. 2, the volutes 218A, 218B are respectively fed by (first and second) exhaust channels 108A, 108B that extend between the engine 100 and the turbocharger 200. The exhaust channels 108A, 108B collect the exhaust gas EG as it exits the exhaust valves 106A, 106B, and direct the exhaust gas EG into the inlets 222A, 222B of the volutes 218A, 218B of the turbine housing 202, respectively. More specifically, the exhaust channel 108A includes a (first) branch 110Ai that collects the exhaust gas EG exiting the exhaust valve 106Ai of the (first) cylinder 102i, a (second) branch 110Aii that collects the exhaust gas EG exiting the exhaust valve 106Bii of the (second) cylinder 102ii, a (third) branch 110Aiii that collects the exhaust gas EG exiting the exhaust valve 106Biii of the (third) cylinder 102iii, and a (fourth) branch 110Aiv that collects the exhaust gas EG exiting the exhaust valve 106Aiv of the (fourth) cylinder 102iv. Correspondingly, the exhaust channel 108B includes a (first) branch 110Bi that collects the exhaust gas EG exiting the exhaust valve 106Bi of the (first) cylinder 102i, a (second) branch 110Bii that collects the exhaust gas EG exiting the exhaust valve 106Aii of the (second) cylinder 102ii, a (third) branch 110Biii that collects the exhaust gas EG exiting the exhaust valve 106Aiii of the (third) cylinder 102iii, and a (fourth) branch 110Biv that collects the exhaust gas EG exiting the exhaust valve 106Biv of the (fourth) cylinder 102iv.

While the exhaust channels 108A, 108B are generally illustrated throughout the figures as discrete conduits that extend between the engine 100 and the volutes 218A, 218B, respectively, in alternate embodiments of the disclosure, the particular configuration and/or location of the exhaust channels 108 may be varied. For example, based upon desired performance, engine configuration, spatial constraints, etc., it is envisioned that the exhaust channels 108 may be incorporated into an exhaust manifold (not shown), the head (not shown) of the engine 100, or any other suitable component.

In a typical engine system including a dual-volute turbocharger, exhaust gas from each cylinder in the engine is directed exclusively into one volute of the turbocharger or the other, which can result in excessive backpressure at higher engine speeds. To address this issue, wastegate valves are often used to reduce the backpressure, as are interconnecting valves in the volute wall, which allow the exhaust gas to cross from one volute to another. These conventional techniques, however, are inefficient in that they squander the energy from the unused exhaust gas.

The engine system 1000 described herein, however, allows for increased control over the flow of the exhaust gas EG, resulting in more efficient operation and backpressure optimization. During operation, the valve positioning system 400 (FIG. 1) is utilized to control and vary flow of the exhaust gas EG into the turbocharger 200. More specifically, the valve positioning system 400 controls the positions of the exhaust valves 106 (e.g. the exhaust valves 106B) such that the exhaust gas EG flows exclusively into the volute 218A, exclusively into the volute 218B, or into a combination of the volutes 218A, 218B. For example, in certain implementations of the engine system 1000, it is envisioned that the exhaust valves 106Ai-106Aiv may be constantly functioning (e.g., opening and closing with the cycles of the engine 100), whereby the exhaust gas EG is constantly flowing from the cylinders 102i, 102iv into the volute 218A through the exhaust channel 108A, and from the cylinders 102ii, 102iii into the volute 218B through the exhaust channel 108B. In such implementations, however, the operation and positioning of the exhaust valves 106Bi-106Biv may be varied (e.g., by the valve positioning system 400) to regulate the extent to which the exhaust gas EG is communicated from the cylinders 102i, 102iv into the volute 218B and from the cylinders 102ii and 102iii into the volute 218A.

In one mode of operation (e.g., at lower engine speeds), for example, each of the exhaust valves 106Bi-106Biv may be closed, whereby the exhaust gas EG from the cylinders 102i, 102iv is directed into the volute 218A through the exhaust channel 108A, and the exhaust gas EG from the cylinders 102ii, 102iii is directed into the volute 218B through the exhaust channel 108B. In the first mode of operation, the cylinders 102i, 102iv are thus, cut off from the volute 218B, and the cylinders 102ii, 102iii are cut off from the volute 218A.

In a second mode of operation, however (e.g., at higher engine speeds), each of the exhaust valves 106Bi-106Biv may be fully opened, whereby the exhaust gas EG from each of the cylinders 102i-102iv is directed into each of the volutes 218A, 218B. More specifically, in the second mode of operation, the volute 218A is fed by the exhaust gas EG from: the exhaust valve 106Ai in the (first) cylinder 102i; the exhaust valve 106Bii in the (second) cylinder 102ii; the exhaust valve 106Biii in the (third) cylinder 102iii; and the exhaust valve 106Aiv in the (fourth) cylinder 102iv. Simultaneously, the volute 218B is fed by the exhaust gas EG from: the exhaust valve 106Bi in the (first) cylinder 102i; the exhaust valve 106Aii in the (second) cylinder 102ii; the exhaust valve 106Aiii in the (third) cylinder 102iii; and the exhaust valve 106Biv in the (fourth) cylinder 102iv.

As the speed of the engine 100 is varied, however (e.g., at intermediate speeds and/or during fluctuation between lower speeds and higher speeds), to facilitate smoother transitions and the controlled modulation of backpressure in a third mode of operation, the valve positioning system 400 may be utilized to vary flow of the exhaust gas EG from the cylinders 102i-102iv into the volutes 218A, 218B (through the exhaust channels 108A, 108B, respectively) by varying the extent to which the exhaust valves 106Bi-106Biv are opened via movement through a plurality of positions. Thus, as in the second mode of operation, the exhaust gas EG from each of the cylinders 102i-102iv is directed into each of the volutes 218A, 218B, but the volume of the exhaust gas EG directed into the volute 218A from the (second and third) cylinders 102ii, 102iii and into the volute 218B from the (first and fourth) cylinders 102i, 102iv can be controlled and varied to achieve any desired result. In the second and third modes, flow of the exhaust gas EG into the volutes 218A, 218B can thus be apportioned in any desired manner by varying the extent to which the exhaust valves 106B are opened to support corresponding functionality of the turbocharger 200.

Embodiments of the disclosure are also contemplated herein in which the configurations and/or orientations of the various components may be altered. For example, in an alternate implementation of the engine system 1000, it is envisioned that the exhaust valves 106Bi-106Biv may be constantly functioning, and thus, constantly open during operation of the engine 100, whereby the exhaust gas EG is constantly flowing from the (first and fourth) cylinders 102i, 102iv into the volute 218B through the exhaust channel 108B and from the (second and third) cylinders 102ii, 102iii into the volute 218A through the exhaust channel 108A. Additionally, embodiments of the disclosure are contemplated in which the arrangement and functionality of the exhaust channels 108A, 108B is reversed such that the exhaust gas EG is directed into the volute 218A from the exhaust valves 106Bi, 106Aii, 106Aiii, and 106Biv through the exhaust channel 108A, and the exhaust gas EG is directed into the volute 218B from the exhaust valves 106Ai, 106Bii, 106Biii, and 106Aiv through the exhaust channel 108B.

In certain embodiments of the engine system 1000, it is also envisioned that the valve positioning system 400 may also be utilized to vary the positions of the exhaust valves 106A as well to further increase control over the flow of the exhaust gas EG into the turbocharger 200, implementations of which are described in further detail below.

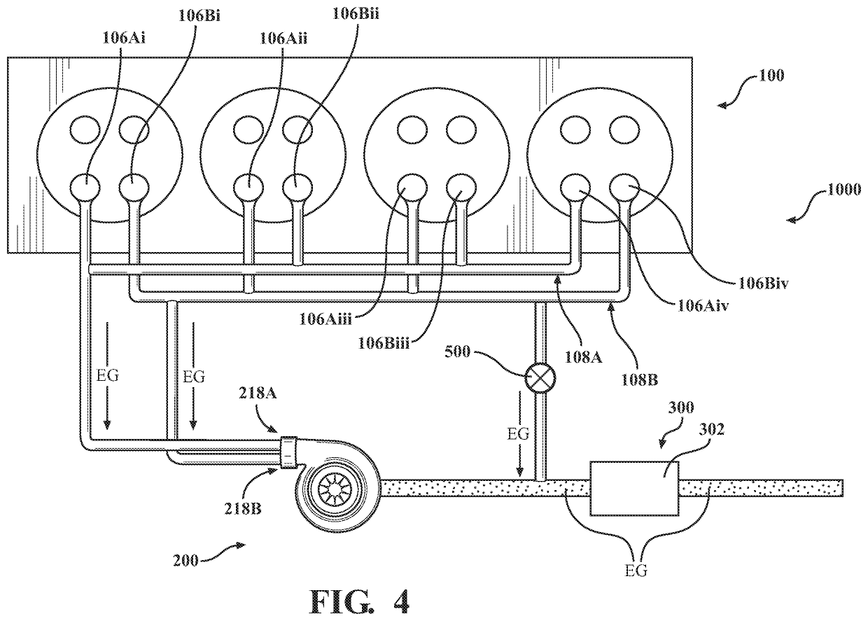

With reference now to FIG. 4, in certain embodiments of the disclosure, a wastegate valve 500 may be included to reduce the volume of the exhaust gas EG entering the turbocharger 200. Although shown as being positioned in the flow path of (or otherwise in communication with) the exhaust channel 108B (i.e., between the engine 100 and the exhaust aftertreatment 302) in alternate embodiments of the disclosure, it is envisioned that the wastegate valve 500 may be positioned in the flow path of (or otherwise in communication with) the exhaust channel 108A.

Conventional dual-volute turbocharger systems typically include two wastegate valves (i.e., one wastegate valve in communication with each volute), or a single valve plate that covers two separate ports. In such systems, the wastegate valves (or ports) are either both opened or closed in order to allow the exhaust gas EG to enter or bypass the turbocharger so as to avoid creating an imbalance. In the engine system 1000 seen in FIG. 4, however, the control over the positions of the exhaust valves 106Bi-106Biv created by the valve positioning system 400 (FIG. 1) allows for the inclusion of a single wastegate valve 500 (or a single port) only.

During operation of the engine system 1000, when the wastegate valve 500 is closed, the volume of the exhaust gas EG entering the turbocharger 200 is evenly apportionable between the volutes 218A, 218B (so as to avoid any imbalance), in that exhaust channels 108A, 108B represent the only two available flow paths. When the wastegate valve 500 is opened, however, a portion of the exhaust gas EG can flow directly from the engine 100 into the exhaust system 300, thereby bypassing the turbocharger 200. When the wastegate valve 500 is opened, the volume of the exhaust gas EG entering the turbocharger 200 is thus reduced, but remains evenly apportioned between the volutes 218A, 218B, thereby preserving balance in the engine system 1000. In addition to facilitating increased control over the flow of the exhaust gas EG into the turbocharger 200, incorporation of the wastegate valve 500 and the valve positioning system 400 also allows for more efficient operation of the exhaust system 300, and in particular, the exhaust aftertreatment 302. As is commonly known, the efficacy of an exhaust aftertreatment is directly related to the temperature of the unit. As the temperature rises (i.e., by virtue of the hot exhaust gas flowing therethrough), the efficacy of the exhaust aftertreatment is increased. Consequently, a vehicle is usually the most pollutive during its operation prior to the exhaust aftertreatment reaching its optimal temperature.

To increase the rate at which the exhaust aftertreatment 302 is heated (and thus reduce the amount of time required for sufficient heating) (e.g., during an initial vehicle startup phase, when the exhaust aftertreatment 302 is cold), as indicated above, the engine system 1000 allows for the exhaust gas EG to bypass the turbocharger 200, and flow directly from the engine 100 into the exhaust aftertreatment 302 by opening the wastegate valve 500. By directing the exhaust gas EG from the engine 100 into the exhaust aftertreatment 302 during the initial startup phase (or thereafter, while the engine 100 is operating), the average temperature of the exhaust gas EG entering the exhaust aftertreatment 302 is increased (when compared to the average temperature of the exhaust gas EG entering the exhaust aftertreatment 302 from the turbocharger 200), thereby reducing the amount of time required to heat the exhaust aftertreatment 302 and increasing the efficiency of operation. To further facilitate flow of the exhaust gas EG directly from the engine 100 into the exhaust aftertreatment 302, the exhaust valves 106Ai, 106Bii, 106Biii, and 106Aiv may be closed (e.g., by the valve positioning system 400) so as to reduce (if not entirely interrupt) flow of the exhaust gas EG into the volutes 218A, 218B, thereby increasing the volume of hot exhaust gas EG flowing through the exhaust channel 108B and the wastegate valve 500 into the exhaust aftertreatment 302.

Persons skilled in the art will understand that the various embodiments of the disclosure described herein and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments. For example, although generally discussed in the context of the front-end of the vehicle V (FIG. 1) herein, as mentioned above, it should be appreciated that any of the various embodiments of the presently disclosed energy absorber may be utilized in the rear-end of the vehicle V as well.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above but is defined by the claims that follow and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated. For example, it is intended that the use of terms such as “approximately” and “generally” should be understood to encompass variations on the order of 25%, or to allow for manufacturing tolerances and/or deviations in design.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A method of controlling exhaust gas flow from a combustion engine including a plurality of cylinders each with first and second exhaust valves to a turbocharger having first and second volutes, the method comprising:
directing exhaust flow from first and second cylinders into the first volute via a first exhaust channel by opening the first exhaust valve in each of the first and second cylinders;
directing exhaust flow from third and fourth cylinders into the second volute via a second exhaust channel by opening the first exhaust valve in each of the third and fourth cylinders; and
apportioning exhaust flow from each cylinder into the first and second volutes via the first and second exhaust channels by moving the second exhaust valve in each cylinder between a variety of positions.

2. The method of claim 1, where apportioning the exhaust flow includes closing the second exhaust valve in each cylinder such that the first volute is fed exclusively by exhaust gas from the first and second cylinders, and the second volute is fed exclusively by exhaust gas from the third and fourth cylinders.

3. The method of claim 2, wherein apportioning the exhaust flow includes partially opening the second exhaust valve in each cylinder such that the exhaust gas from each cylinder is at least partially directed into each of the first and second volutes.

4. The method of claim 3, wherein apportioning the exhaust flow includes fully opening the second exhaust valve in each cylinder.

5. The method of claim 1, further including repositioning a single wastegate valve positioned downstream of the combustion engine to simultaneously vary the exhaust flow into the first and second exhaust channels and the first and second volutes.

6. The method of claim 5, wherein repositioning the wastegate valve includes opening the wastegate valve to simultaneously reduce the exhaust flow into the first and second volutes.

7. The method of claim 6, further including positioning the first and second exhaust valves in each cylinder such that the exhaust flow is prohibited from entering the first exhaust channel, whereby the exhaust flow is directed exclusively into the second exhaust channel.

8. The method of claim 7, wherein positioning the first and second exhaust valves to prohibit exhaust flow into the first exhaust channel occurs prior to, or during, an initial startup phase.

9. The method of claim 8, wherein opening the wastegate valve causes a portion of exhaust gas from the combustion engine to bypass the turbocharger and flow directly from the combustion engine into an exhaust aftertreatment positioned downstream of the turbocharger through the wastegate valve to thereby increase a rate at which the exhaust aftertreatment is heated.

10. An engine system, comprising:
a combustion engine including a plurality of cylinders, each cylinder including a first exhaust valve and a second exhaust valve;
a turbocharger in communication with the combustion engine, the turbocharger including a first volute having an inlet and an outlet, and a second volute having an inlet and an outlet; and
a valve positioning system configured to reposition the first and second exhaust valves in each cylinder such that the combustion engine is operable in a plurality of modes including:
a first mode, in which the first exhaust valve of each cylinder is fully open and the second exhaust valve of each cylinder is closed such that the first volute is fed exclusively by exhaust gas from a first plurality of cylinders through a first exhaust channel, and the second volute is fed exclusively by exhaust gas from a second, different plurality of cylinders through a second exhaust channel;
a second mode, in which the first and second exhaust valves of each cylinder are fully open such that exhaust gas from each cylinder flows into each of the first and second volutes; and
a third mode, in which the first exhaust valve of each cylinder is fully open and the second exhaust valve of each cylinder is partially open to vary exhaust flow from each cylinder into each of the first and second volutes.

11. The engine system of claim 10, wherein the plurality of cylinders includes a first cylinder, a second cylinder, a third cylinder, and a fourth cylinder.

12. The engine system of claim 11, wherein the valve positioning system is configured such that, in the first mode, the first volute is fed exclusively by exhaust gas from the first and fourth cylinders and the second volute is fed exclusively by exhaust gas from the second and third cylinders.

13. The engine system of claim 10, further including a single wastegate valve positioned downstream of the combustion engine to simultaneously vary the exhaust flow into the first and second volutes.

14. The engine system of claim 13, wherein the wastegate valve is positioned in communication with the second exhaust channel.

15. The engine system of claim 13, further including an exhaust aftertreatment positioned downstream of the turbocharger, the wastegate valve being positioned upstream of the exhaust aftertreatment.

16. The engine system of claim 15, wherein the wastegate valve is movable between an open position, in which a portion of the exhaust gas from the combustion engine bypasses the turbocharger and flows directly into the exhaust aftertreatment, and a closed position, in which exhaust gas is prevented from bypassing the turbocharger and flowing directly from the combustion engine into the exhaust aftertreatment.

17. A method of operating a vehicle powered by a turbocharger having first and second volutes, and a combustion engine having a plurality of cylinders each with first and second exhaust valves, the method comprising:
positioning the first and second exhaust valves in each cylinder such that exhaust gas is prohibited from flowing into a first exhaust channel extending between the combustion engine and the first volute of the turbocharger, whereby the exhaust gas flows exclusively into a second exhaust channel extending between the combustion engine and the second volute of the turbocharger; and
opening a wastegate valve positioned between the combustion engine and the turbocharger such that a portion of the exhaust gas bypasses the turbocharger and flows directly from the combustion engine into an exhaust aftertreatment positioned downstream of the turbocharger to thereby increase a rate at which the exhaust aftertreatment is heated, and increase performance of the exhaust aftertreatment during an initial startup phase of the vehicle.

18. The method of claim 17, further including operating the vehicle in a first mode, after the initial startup phase is complete, in which the first exhaust valve of each cylinder is open and the second exhaust valve of each cylinder is closed such that the first volute is fed exclusively by exhaust gas from a first plurality of cylinders, and the second volute is fed exclusively by exhaust gas from a second, different plurality of cylinders.

19. The method of claim 18, further including operating the vehicle in a second mode in which the first and second exhaust valves of each cylinder are fully open such that exhaust gas from each cylinder flows into each of the first and second volutes.

20. The method of claim 19, further including operating the vehicle in a third mode, occurring between the first mode and the second mode, in which the second exhaust valve of each cylinder is partially open to vary exhaust flow from each cylinder into each of the first and second volutes.
